(19) United States
(12) Patent Application Publication
(10) Pub. No.: US 2017/0031838 A1
(43) Pub. Date: Feb. 2, 2017

(54) METHOD AND APPARATUS FOR USING CONTEXT INFORMATION TO PROTECT VIRTUAL MACHINE SECURITY

(71) Applicant: QUALCOMM Incorporated, San Diego, CA (US)

(72) Inventors: Satyaki Mukherjee, Bangalore (IN); Subodh Singh, Bangalore (IN); Ajaykumar Shankargouda Patil, Bangalore (IN); Thomas Zeng, San Diego, CA (US); Azzedine Touzni, Carlsbad, CA (US)

(21) Appl. No.: 14/811,296

(22) Filed: Jul. 28, 2015

(51) Int. Cl. G06F 12/14; G06F 9/455

(52) U.S. Cl. CPC G06F 12/1441; G06F 9/45558; G06F 2212/1052; G06F 2009/45587

(57) ABSTRACT

Disclosed is a method for protecting virtual machine data at a peripheral subsystem connected to at least one processor configured to host a plurality of virtual machines. In the method, context information, including a virtual machine identifier (VMID), is received. The VMID is unique to one of the plurality of virtual machines. A storage bank of a plurality of storage banks is selected based on the VMID included in the received context information. Each storage bank of the plurality of storage banks uses a same bus address range. A data bus is connected to the selected storage bank.

### BACKGROUND

Field

The present disclosure relates generally to protecting the security of information at peripheral hardware shared by multiple virtual machines.

Background

Peripheral hardware and resources may be shared by multiple operating systems running within different virtual machines. A virtual machine manager (i.e., hypervisor) is designed to ensure stability and security so that incorrect operation (either due to software bug or an intentionally incorrect operation by malicious software) by one operating system or process does not compromise the stability and security of the processes that are working normally. The virtual machine manager uses software and tables to manage which virtual machine is accessing a peripheral resource, which requires substantial memory storage and manager level peripheral drivers.

In current implementations of an ARM processor, a peripheral resource may receive a signal (PROTNS) indicating whether the current access is secure or not. Peripheral resources owned and controlled by software running in a secure mode are not accessible to processes running in a non-secure mode without the consent of the secure software. However, incorrect operation by one operating system may allow compromise of secure information by exposing the secure information shared by another operating system with the peripheral resource.

There is therefore a need for a technique for efficiently securing information shared with a peripheral resource.

### SUMMARY

An aspect of the invention may reside in a method for protecting data at a peripheral resource connected to at least one processor configured to host a plurality of virtual machines. In the method, context information, including a virtual machine identifier (VMID), is received. The VMID is unique to one of the plurality of virtual machines. A storage bank of a plurality of storage banks is selected based on the VMID included in the received context information. Each storage bank of the plurality of storage banks uses a same bus address range. A data bus is connected to the selected storage bank.

In more detailed aspects of the invention, each storage bank may comprise a register and data buffer bank. Also, each storage bank may comprise a plurality of addressable storage locations. The context information may further comprise a single bit secure process signal. The VMID may comprise four, eight, or sixteen bits.

In other more detailed aspects of the invention, second context information, including a second virtual machine identifier (VMID2), may be received. The VMID2 may be unique to another one of the plurality of virtual machines. A second storage bank of the plurality of storage banks may be selected based on the VMID2 included in the received second context information. The data bus may be disconnected from the selected storage bank, and connected to the selected second storage bank.

Another aspect of the invention may reside in an apparatus, comprising: means for receiving context information including a virtual machine identifier (VMID), wherein the VMID is unique to one of a plurality of virtual machines; means for selecting a storage bank of a plurality of storage banks based on the VMID included in the received context information, wherein each storage bank of the plurality of storage banks uses a same bus address range; and means for connecting a data bus to the selected storage bank.

Another aspect of the invention may reside in an apparatus, comprising: a data bus connected to at least one processor configured to host a plurality of virtual machines, wherein each virtual machine of the plurality of virtual machines is associated with a unique virtual machine identifier (VMID); a plurality of storage banks, wherein a same bus address range is used for each storage bank of the plurality of storage banks; and a multiplexer configured to: receive context information including a VMID, select a storage bank of the plurality of storage banks, based on the VMID included in the received context information, and connect the selected storage bank to the data bus.

Another aspect of the invention may reside in a computer-readable medium, comprising: code for causing a computer to receive context information including a virtual machine identifier (VMID), wherein the VMID is unique to one of a plurality of virtual machines; code for causing the computer to select a storage bank of a plurality of storage banks based on the VMID included in the received context information, wherein each storage bank of the plurality of storage banks uses a same bus address range; and code for causing the computer to connect a data bus to the selected storage bank.

### BRIEF DESCRIPTION OF THE DRAWINGS

FIG. 1 is a flow diagram of a method for using context information including a virtual machine identifier (VMID) for protecting the security of information at a peripheral hardware/resource shared by multiple virtual machines, according to aspects of the present invention.

FIG. 2 is a block diagram of virtual machines securely sharing a peripheral, according to aspects of the present invention.

FIG. 3 is a schematic diagram of peripheral having a plurality of storage banks having a same bus address range.

FIG. 4 is a block diagram showing an example of a computer for implementing the aspects of the invention.

FIG. 5 is a block diagram of an example of a wireless communication system.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

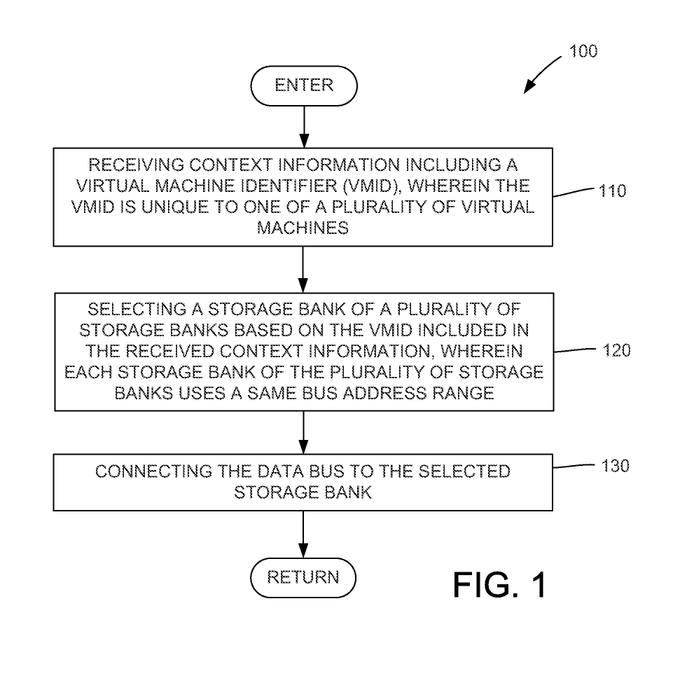

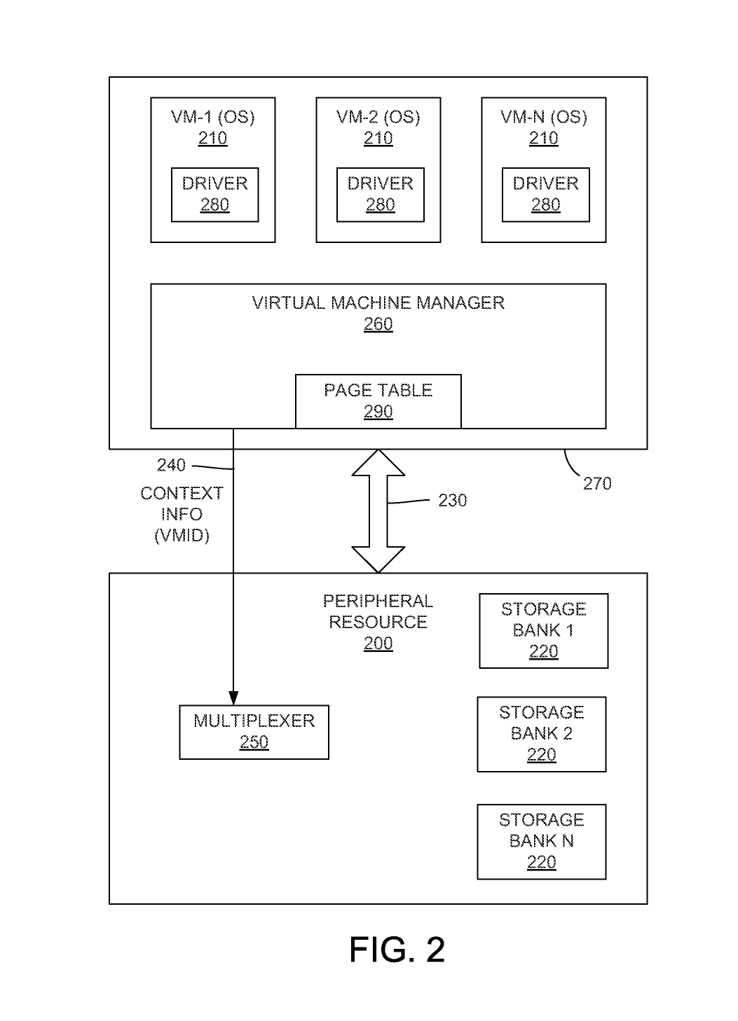

With reference to FIGS. 1-3, an aspect of the invention may reside in a method 100 (FIG. 1) for protecting data at a peripheral resource 200 (FIG. 2) (i.e., a hardware subsystem) connected to at least one processor 270 configured to host a plurality of virtual machines 210. In the method 100, context information, including a virtual machine identifier (VMID), is received (block 110). The VMID is unique to one of the plurality of virtual machines. A storage bank 220 of a plurality of storage banks is selected based on the VMID included in the received context information (block 120). Each storage bank 220 of the plurality of storage banks uses a same bus address range (e.g., A1-A6). A data bus 230 is connected to the selected storage bank 220 (block 130).

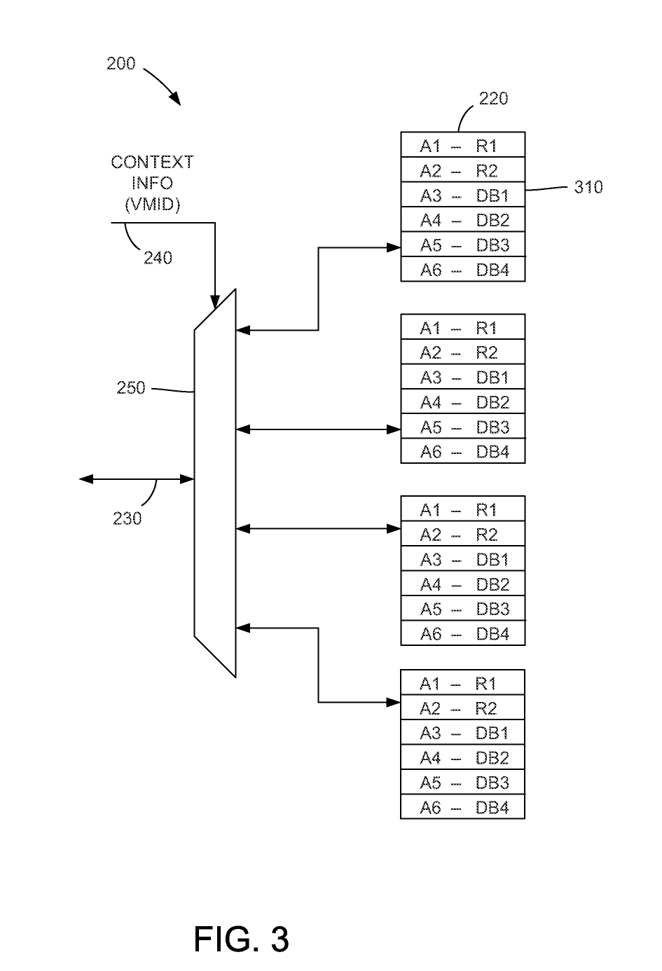

In more detailed aspects of the invention, each storage bank 220 may comprise a register and data buffer bank. Also, each storage bank 220 may comprise a plurality of addressable storage locations 310 (FIG. 3). The context information may further comprise a single-bit secure process signal.

The context information may be received over a secure control bus 240. A multiplexer 250 may use the VMID to select a storage bank 220, and may connect the selected storage bank 220 to the data bus 230. Each storage location 310 of a storage bank 220 has an address. Each storage bank 220 uses the same address range, A1 to A6. As shown in FIG. 3, two of the storage locations correspond to two registers, R1 and R2, and four of the storage locations correspond to four data buffers, DB1 to DB4. Only six addressable storage locations are shown for simplicity of explanation, Addressing schemes and location configurations are not limited to the simple exemplary configuration shown in FIG. 3.

Accordingly, each virtual machine 210 may have access to the entire address range associated with the peripheral resource 200 because each virtual machine 210 is associated with, and may only access, a separate and unique storage bank 220 selected based on the virtual machines' unique VMID value. Also, a storage bank 220 associated with another virtual machine 210 is not available. The multiplexer 250 only allows a virtual machine 210 to have access to one selected storage bank 220, and only that virtual machine 210 has access to that one selected storage bank 220. As a result, incorrect operation of one operating system (operating in a virtual machine 210) may not compromise secure information shared by another operating system (operating in another virtual machine 210) with the peripheral resource 200.

In other more detailed aspects of the invention, second context information, including a second virtual machine identifier (VMID2), may be received. The VMID2 may be unique to another one of the plurality of virtual machines 210. A second storage bank 220 of the plurality of storage banks may be selected based on the VMID2 included in the received second context information. The data bus 230 may be disconnected from the selected storage bank 220, and connected to the selected second storage bank 220.

In ARM or other processors running multiple operating systems and using virtualization extensions, an operating system is identified by a Virtual Machine ID (VMID) value of a virtual machine manager 260. The VMID values are used within a memory management unit (MMU) (not shown) inside the processor 270. The VMID may comprise multiple bits such as, for example, four, eight, or sixteen bits.

The VMID value is propagated from the processor 270 (i.e., an application processor/CPU) as part of the context information with every transaction made by the processor 270 with a peripheral resource 200. The processor's MMU and Bus Interface Unit (BIU) (not shown) include the VMID value in the context information. A secure process/access protection signal (e.g., a single-bit PROTNS signal in an ARM processor of the ARMv7 architecture) may be propagated as part of the context information to ensure that all secure accesses have a unique context information value that cannot be imitated by a virtual machine 210 making non-secure accesses. Thus, an existing mechanism that prevents less privileged non-secure virtual machines from accessing secure resources is not disrupted. Accordingly, multiple operating systems/clients (through virtual machines 210) may access the multi-client peripheral resources directly using a standard peripheral driver 280 instead of through a manager layer of software that validates and arbitrates these accesses. The virtual machine manager 260 may use just a single and simple page table 290 and may expose the entire address space/map to each virtual machine 210. The VMID value may be used by a multi-client peripheral resource 200 to determine the register bank/data buffers that the multi-client peripheral resource 200 provides access to at any given instance.

An apparatus having virtual machine data protection may be a mobile/remote station 400 that may include a computer 410. The computer 410 may include a processor 420, a storage device 430 such as memory and/or disk drives, a multi-client peripheral subsystem 440, a display 450, and keypad or keyboard 460. The computer 410 may also include a microphone, speaker(s), camera, and the like. Further, the device may also include an antenna 470 for wireless communications, and/or USB, Ethernet and similar interfaces 480 for wired communications, with other devices and/or servers over a network such as the internet.

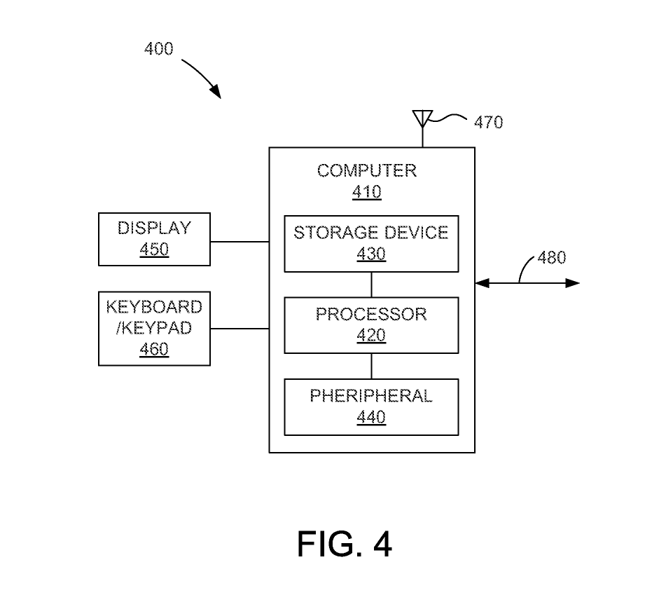

Another aspect of the invention may reside in an apparatus, comprising: means (e.g., processor 420 (FIG. 4)) for receiving context information including a virtual machine identifier (VMID), wherein the VMID is unique to one of a plurality of virtual machines 210 (FIG. 2); means (e.g., processor 420) for selecting a storage bank 220 of a plurality of storage banks based on the VMID included in the received context information, wherein each storage bank 220 of the plurality of storage banks uses a same bus address range; and means (e.g., processor 420) for connecting a data bus 230 to the selected storage bank 220.

Another aspect of the invention may reside in an apparatus, comprising: a data bus 230 connected to at least one processor 270 configured to host a plurality of virtual machines 210, wherein each virtual machine 210 of the plurality of virtual machines is associated with a unique virtual machine identifier (VMID); a plurality of storage banks, wherein a same bus address range is used for each storage bank 220 of the plurality of storage banks; and a multiplexer 250 configured to: receive context information including a VMID, select a storage bank 220 of the plurality of storage banks, based on the VMID included in the received context information, and connect the selected register bank to the data bus 230.

Another aspect of the invention may reside in a computer-readable medium 430, comprising: code for causing a computer 410 to receive context information including a virtual machine identifier (VMID), wherein the VMID is unique to one of a plurality of virtual machines 210; code for causing the computer 410 to select a storage bank 220 of a plurality of storage banks based on the VMID included in the received context information, wherein each storage bank 220 of the plurality of storage banks uses a same bus address range; and code for causing the computer 410 to connect a data bus 230 to the selected storage bank 220.

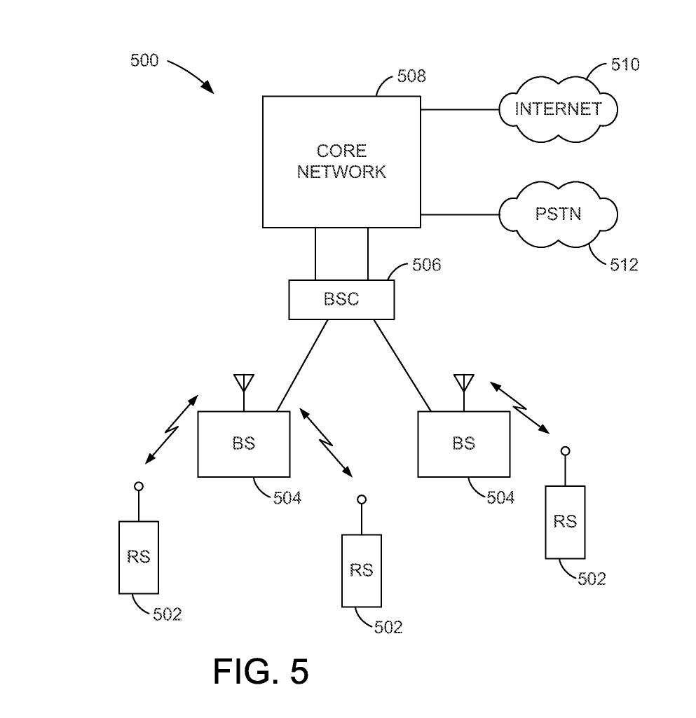

With reference to FIG. 5, a wireless remote station (RS) 502 (user equipment UE and/or mobile station 400 (FIG. 4) incorporating a peripheral resource 200 (FIG. 2)) may communicate with one or more base stations (BS) 504 of a wireless communication system 500. The RS 502 may further pair with a wireless peer device. The wireless communication system 500 may further include one or more base station controllers (BSC) 506, and a core network 508. The core network 508 may be connected to an Internet 510 and a Public Switched Telephone Network (PSTN) 512 via suitable backhauls. A wireless mobile station may include a handheld phone, or a laptop computer. The wireless communication system 500 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two, A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on as one or more instructions or code on a computer-readable medium. Computer-readable media includes computer storage media that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory such that it does not include a transitory, propagating signal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for virtual machine data protection, comprising:
receiving context information including a virtual machine identifier (VMID), wherein the VMID is unique to one of a plurality of virtual machines;
selecting a storage bank of a plurality of storage banks based on the VMID included in the received context information, wherein each storage bank of the plurality of storage banks uses a same bus address range; and
connecting a data bus to the selected storage bank.

2. The method of claim 1 wherein each storage bank comprises a register and data buffer bank.

3. The method of claim 1, wherein each storage bank comprises a plurality of addressable storage locations.

4. The method of claim 1, further comprising:
receiving second context information including a second virtual machine identifier (VMID2), wherein the VMID2 is unique to another one of the plurality of virtual machines;
selecting a second storage bank of the plurality of storage banks based on the VMID2 included in the received second context information;
disconnecting the data bus from the selected storage bank; and
connecting the data bus to the selected second storage bank.

5. The method of claim 2, wherein the context information further comprises a secure process signal.

6. The method of claim 5, wherein the secure process signal comprises one bit.

7. The method of claim 6, wherein the VMID comprises four bits.

8. The method of claim 6, wherein the VMID comprises eight bits.

9. The method of claim 6 wherein the VMID comprises sixteen bits.

10. An apparatus having virtual machine data protection, comprising:
a data bus connected to at least one processor configured to host a plurality of virtual machines, wherein each virtual machine of the plurality of virtual machines is associated with a unique virtual machine identifier (VMID);
a plurality of storage banks, wherein a same bus address range is used for each storage bank of the plurality of storage banks; and
a multiplexer configured to:
receive context information including a VMID,
select a storage bank of the plurality of storage banks, based on the VMID included in the received context information, and
connect the selected storage bank to the data bus.

11. The apparatus of claim 10, wherein each storage bank comprises a register and data buffer bank.

12. The apparatus of claim 10, wherein each storage bank comprises a plurality of addressable storage locations.

13. The apparatus of claim 10, wherein the multiplexer is farther configured to:
receive second context information including a second virtual machine identifier (VMID2),
select a second storage bank of the plurality of storage banks, based on the VMID2 included in the received second context information, and
connect the second selected storage bank to the data bus.

14. The apparatus of claim 10, wherein the context information further comprises a secure process signal.

15. The apparatus of claim 14 wherein the secure process signal comprises one bit.

16. The apparatus of claim 15, wherein the VMID comprises four bits.

17. A computer-readable medium, comprising:
code for causing a computer to receive context information including a virtual machine identifier (VMID), wherein the VMID is unique to one of a plurality of virtual machines;
code for causing the computer to select a storage bank of a plurality of storage banks based on the VMID included in the received context information, wherein each storage bank of the plurality of storage banks uses a same bus address range; and
code for causing the computer to connect a data bus to the selected storage bank.

18. The computer-readable medium of claim 17, wherein each storage bank comprises a register and data buffer bank.

19. The computer-readable medium of claim 17 wherein each storage bank comprises a plurality of addressable storage locations.

20. The computer-readable medium of claim 17, further comprising:
code for causing the computer to receive second context information including a second virtual machine identifier (VMID2), wherein the VMID2 is unique to another one of the plurality of virtual machines;
code for causing the computer to select a second storage bank of the plurality of storage banks based on the VMID2 included in the received second context information;
code for causing the computer to disconnect the data bus from the selected storage bank; and
code for causing the computer to connect the data bus to the selected second storage bank.
